(19) United States
(12) Patent Application Publication
(10) Pub. No.: US 2023/0059533 A1
(43) Pub. Date: Feb. 23, 2023

(54) A COIL ASSEMBLY AND METHOD OF TERMINATING A COIL TO A CIRCUIT BOARD

(71) Applicant: 3M INNOVATIVE PROPERTIES COMPANY, St. Paul, MN (US)

(72) Inventors: Jinwook Kim, Hwaseong-si (KR); Seong-Woo Woo, Gwangju-si (KR); Dongeun Lee, Anyang-si (KR); Sang-Jun Mo, Suwon-si (KR); Jung Ju Suh, Seocho-gu (KR)

(21) Appl. No.: 17/796,013

(22) PCT Filed: Feb. 1, 2021
(86) PCT No.: PCT/IB2021/050797

§ 371 Date: Jul. 28, 2022

(30) Foreign Application Priority Data
Feb. 4, 2020 (KR) 10-2020-0013364

(51) Int. Cl. H01F 17/00; H01F 41/061; H01F 41/04

(52) U.S. Cl. CPC H01F 17/0013; H01F 41/061; H01F 41/043; H01F 2017/0066

(57) ABSTRACT

The present disclosure relates to a coil assembly. According to a first embodiment of the present disclosure, there is provided a coil assembly including a coil including a multilayer film which is extended between a first longitudinal end and a second longitudinal end of the multilayer film, which are opposite to each other, and which is wound to form a plurality of loops which are substantially concentric, wherein the multilayer film includes: cut edges which are extended between the first longitudinal end and the second longitudinal end, and are opposite to each other and are substantially parallel to each other; a metal layer; and a magnetic layer disposed on the metal layer, wherein, at one or more of the first longitudinal end and the second longitudinal end of the multilayer film, the metal layer is electrically connected to a conductive terminal.

### BACKGROUND

### Technical Field

The present disclosure relates to a coil assembly and a method of terminating a coil to a circuit board.

### Background Art

In general, an electronic product having a battery embedded therein like a portable terminal needs to be charged with power. Recently, systems for wirelessly transmitting power to charge a battery embedded in a portable terminal, etc. are increasingly used, and researches on such wireless power transmission systems are ongoing.

Such a wireless charging device includes a power transmission device to transmit power and a power reception device to wirelessly receive power and to store the power. In addition, the wireless charging device transmits and receives power by using electromagnetic induction or resonance, and to achieve this, coils are provided in respective devices. The coil may be terminated to a circuit board where a circuit is formed to transmit and receive power. In particular, the coil may need to be electrically terminated to the circuit board, and should be terminated to the circuit board not to be separated therefrom. For example, welding may be used in a process of electrically terminating the coil to the circuit board.

However, when the coil is terminated to the circuit board according to related-art technology, the laser welding method may cause not only the coil but also the circuit board to be penetrated. In addition, the related-art laser, ultrasonic and resistance welding methods may cause a thickness of the circuit board to increase by by-products generated in the process of terminating the coil to the circuit board. The problems arising in the process of terminating the coil to the board as described above may increase contact resistance and thus may reduce wireless power transmission efficiency. Accordingly, there is a demand for a device and a method for minimizing contact resistance by reducing a damage to a circuit board when a coil is electrically terminated to the circuit board.

### SUMMARY

### Technical Problem

Embodiments of the present disclosure have been invented by considering the above-described background, and provide a coil assembly which can minimize contact resistance and thickness increase when a coil is electrically terminated to a circuit board.

### Technical Solution

According to one aspect of the present disclosure, there is provided a coil assembly including a coil including a multilayer film which is extended between a first longitudinal end and a second longitudinal end of the multilayer film, which are opposite to each other, and which is wound to form a plurality of loops which are substantially concentric, wherein the multilayer film includes: cut edges which are extended between the first longitudinal end and the second longitudinal end, and are opposite to each other and are substantially parallel to each other; a metal layer; and a magnetic layer disposed on the metal layer, wherein, at one or more of the first longitudinal end and the second longitudinal end of the multilayer film, the metal layer is electrically connected to a conductive terminal.

In addition, there is provided a coil assembly including a coil including a continuous wire which is wound to form a plurality of loops, the plurality of loops including an outermost loop including a first end of the wire, and an innermost loop including a second end opposite to the first end of the wire, the plurality of loops being substantially concentric, wherein the wire includes a plurality of stacking layers which have substantially coextensive length and width between the first end and the second end of the wire, respectively, wherein the plurality of stacking layers include a magnetic layer and a plurality of metal layers and a plurality of adhesive layers which are alternated, wherein, at the first end and the second end of the wire, respectively, the plurality of metal layers are electrically, physically connected with one another, and are electrically, physically connected to a conductive terminal of a flexible circuit board.

### Advantageous Effects

According to embodiments of the present disclosure, there is an effect of minimizing contact resistance and a thickness increase when a coil is electrically terminated to a circuit board.

### BRIEF DESCRIPTION OF THE DRAWINGS

FIG. 1 is a top view of a coil assembly according to a first embodiment of the present disclosure;

FIG. 2 is a cross-sectional view taken on line A-A′ of FIG. 1;

FIG. 3 is a cross-sectional view of a multilayer film of FIG. 1;

FIG. 4 is an enlarged view of B of FIG. 1;

FIG. 5 is a view illustrating a state in which a laser is projected onto the coil assembly of FIG. 1;

FIG. 6 is a rear view of a coil assembly according to a second embodiment of the present disclosure;

FIG. 7 is a view illustrating a state in which a laser is projected onto the coil assembly of FIG. 6;

FIG. 8 is a cross-sectional view of a coil assembly according to a third embodiment of the present disclosure;

FIG. 9 is a top view of a coil assembly according to a fourth embodiment of the present disclosure;

FIG. 10 is a schematic cross-sectional view of the coil assembly of FIG. 9;

FIG. 11 is a schematic cross-sectional view of a coil assembly according to a fifth embodiment of the present disclosure;

FIG. 12 is a top view schematically illustrating a coil assembly according to a sixth embodiment of the present disclosure;

FIG. 13 is a schematic cross-sectional view of the coil assembly of FIG. 12;

FIG. 14 is a cross-sectional view of a coil assembly according to a seventh embodiment of the present disclosure;

FIG. 15 is a view illustrating a state in which a laser is projected onto the coil assembly of FIG. 14;

FIG. 16 is a view illustrating a state in which a laser is projected onto a metal layer of the coil assembly of FIG. 14;

FIG. 17 is a view illustrating a state in which a laser is projected onto a coil assembly according to an eighth embodiment of the present disclosure; and

FIG. 18 is a sequence diagram schematically illustrating a method of terminating a coil to a flexible circuit board according to an embodiment of the present disclosure.

### DETAILED DESCRIPTION

Hereinafter, specific embodiments for implementing the concept of the present disclosure will be described in detail with reference to the drawings.

Further, in explaining the present disclosure, any specific explanation on a well-known related configuration or function deemed to obscure the gist of the present disclosure will be omitted.

In addition, it should be understood that, when a certain element is referred to as being “connected to,” “supported on,” “terminated to,” “bonded to,” or “coupled to,” or “contacting” another element, the certain element can be directly connected to, supported on, terminated to, bonded to, coupled to, contact another element, but there may be an intervening element therebetween.

The terms used herein are only for describing certain exemplary embodiments, and not intended to limit the scope of the disclosure. Unless otherwise specified, a singular expression includes a plural expression.

In addition, throughout the description, the expressions “upper side,” “lower side,” “side surface” or the like are described with reference to illustrations in the drawings, and it is to be noted that these may be expressed differently when the orientation of a corresponding object is changed. For the same reason, some element may be exaggerated, omitted or schematically illustrated in the drawings, and the size of each element does not entirely reflect a real size.

In addition, the terms including ordinal numbers such as ‘first’ and ‘second’ may be used to describe various elements, but these elements should not be limited by such terms. These terms are used for the purpose of distinguishing one element from another element only.

The term “includes” used in this specification specifies a specific feature, area, integer, step, operation, element, and/or component, and does not preclude the presence or addition of other specific features, areas, integers, steps, operations, elements, components, and/or groups.

Hereinafter, a detailed configuration of a coil assembly 1 according to a first embodiment of the present disclosure will be described with reference to the drawings.

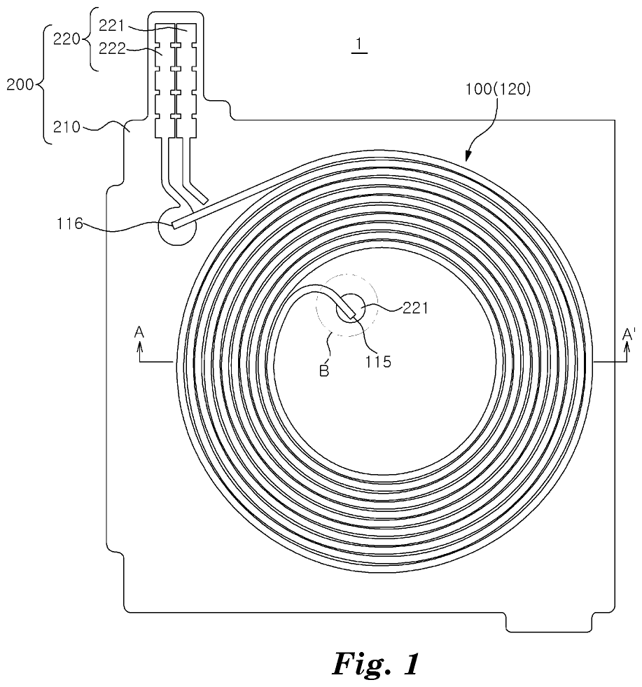

Hereinafter, referring to FIG. 1, the coil assembly 1 according to the first embodiment of the present disclosure may transmit and receive power. For example, the coil assembly 1 may be used for a wireless charging device for charing a battery, and may transmit and receive power through electromagnetic induction. The coil assembly 1 may include a coil 100 and a flexible circuit board 200.

The coil 100 may provide a portion through which current flows. The coil 100 may be electrically connected to the flexible circuit board 200, and may be disposed on the flexible circuit board 200. The coil 100 may include a multilayer film 110.

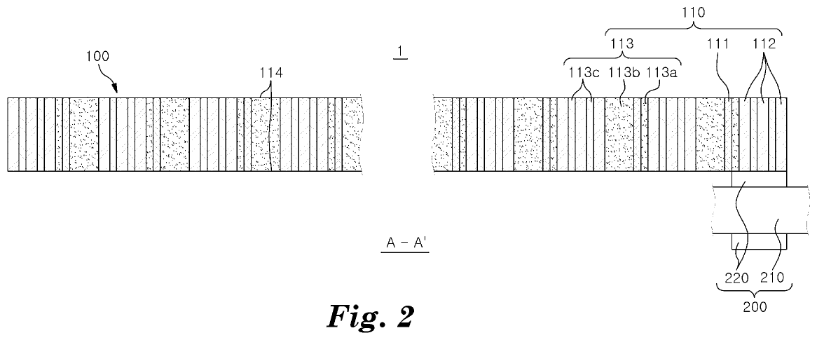

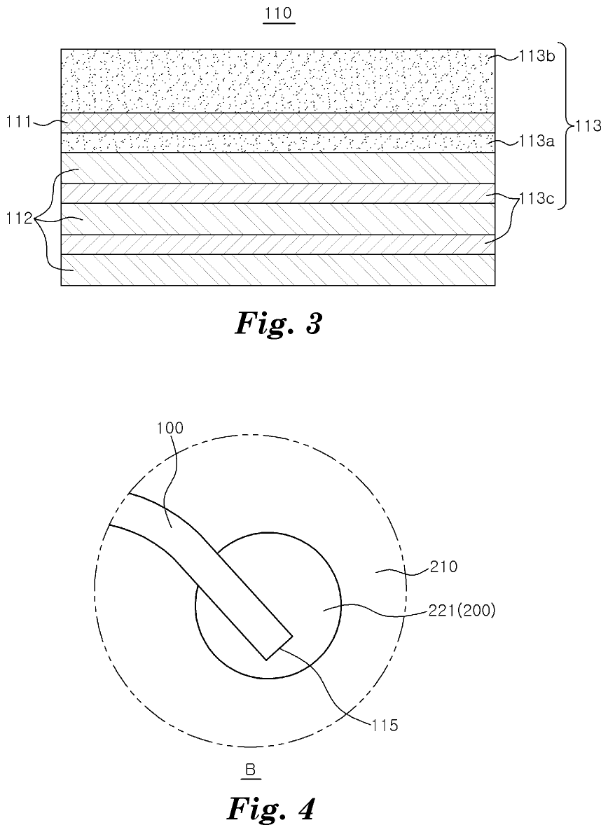

Referring to FIGS. 2 and 3, the multilayer film 110 may have a multilayer structure, and may include a conductive material through which current flows. The multilayer film 110 may include a magnetic layer 111, a metal layer 112, an adhesive layer 113 bonding the magnetic layer 111 and the metal layer 112, and cut edges 114. In addition, the multilayer film 110 may be extended between a first longitudinal end 115 and a second longitudinal end 116 which are opposite to each other, and may be wound to form a plurality of loops 120 which are substantially concentric. In other words, the multilayer film 110 may be provided to form the plurality of loops 120 by winding a linear long film multiple times. The first longitudinal end 115 may refer to an end of one side of the multilayer film 110 in the length direction, and the second longitudinal end 116 may refer to an end of the opposite side of the multilayer film 110 in the length direction. Herein, the length direction may be a direction in which the multilayer film 110 is extended.

The magnetic layer 111 may include a material having magnetism. A plurality of magnetic layers 111 may be provided, and may be bonded to one surface of the adhesive layer 113 to be bonded to the metal layer 112. In other words, the magnetic layer 111 may be attached to the metal layer 112 through a first adhesive layer 113a provided between the magnetic layer 111 and the metal layer 112. The magnetic layer 111 may be disposed on the first adhesive layer 113a, and may be disposed between the first adhesive layer 113a and a second adhesive layer 113b.

The metal layer 112 may include a metallic material through which current flows. A plurality of metal layers 112 may be provided, and may be bonded to one surface of the adhesive layer 113. In addition, the metal layer 112 may be electrically, physically connected to a conductive terminal 220 disposed on an insulation layer 210 of the flexible circuit board 200. In addition, the metal layer 112 may be electrically connected to the conductive terminal 220, which will be described below, at one or more of the first longitudinal end 115 and the second longitudinal end 116. A welding portion 112a may be provided on the metal layer 112, and the metal layer 112 may be electrically, physically connected to the conductive terminal 220 through the welding portion 112a. The welding portion 112a may be provided not only on the metal layer 112, but also on the conductive terminal 220. In other words, the welding portion 112a may be provided on one or more of the metal layer 112 and the conductive terminal 220.

The adhesive layer 113 may bond a plurality of layers therebetween. A plurality of adhesive layers 113 may be provided, and the plurality of adhesive layers 113 may include the first adhesive layer 113a, the second adhesive layer 113b, and a third adhesive layer 113c.

The first adhesive layer 113a may bond the magnetic layer 111 and the metal layer 112 to each other. The first adhesive layer 113a may be disposed between the magnetic layer 111 and the metal layer 112.

The second adhesive layer 113b may couple adjacent loops 120 out of the plurality of loops 120 which are substantially concentric. In other words, the second adhesive layer 113b may couple adjacent loops 120 by bonding the metal layer 112 of one of the plurality of loops 120 and the magnetic layer 111 adjacent to the metal layer 112 of the plurality of loops 120.

The third adhesive layer 113c may bond some of the plurality of metal layer 112 to each other. The cut edges 114 may be extended between the first longitudinal end 115 and the second longitudinal end 116. The cut edges 114 may refer to one surface (for example, an upper surface or a lower surface of FIG. 2) of the multilayer film 110. In addition, the cut edges 114 may be disposed opposite to each other and may be substantially parallel to each other.

Referring back to FIG. 1, the flexible circuit board 200 may support the coil 100, and may be physically, electrically connected with the coil 100. In addition, the flexible circuit board 200 may allow current to flow therethrough, and may transmit the current to the coil 100. For example, the flexible circuit board 200 may be a flexible printed circuit board (FPCB). The flexible circuit board 200 may include the insulation layer 210, the conductive terminal 220.

The insulation layer 210 may support the conductive terminal 220. The insulation layer 210 may be an electrically insulated layer. For example, the insulation layer 210 may include a plastic resin such as polyimide. A refractive index of the insulation layer 210 including polyimide may be 1.5-1.89 inclusive. As described above, the insulation layer 210 may have a similar refractive index to that of the air, such that a laser projected onto the insulation layer 210 can be reflected within the insulation layer 210. Accordingly, a laser is repeatedly reflected between two surfaces of the insulation layer 210 facing each other, such that the conductive terminal 220 can melt even by a low power laser.

The conductive terminal 220 may be electrically connected to the coil 100. The conductive terminal 220 may be electrically connected with the first longitudinal end 115 and the second longitudinal end 116 of the coil 100. In addition, the conductive terminal 220 may be disposed on both side surfaces of the insulation layer 210. For example, the conductive terminal 220 may include copper (Cu). The conductive terminal 220 may include a first terminal 221 and a second terminal 222.

Referring to FIGS. 1 and 4, the first terminal 221 may be provided as one or more metal layers connected with the first longitudinal end 115 of the coil 100. In other words, a portion of the first terminal 221 may be electrically, physically connected with the first longitudinal end 115 of the coil 100 disposed inside the loop 120 of the coil 100. When the first terminal 221 is a single metal layer, the first terminal may be disposed on one surface of the insulation layer 210. When the first terminal 221 includes a plurality of metal layers, one metal layer included in the first terminal 221 may be supported on one side surface of the insulation layer 210 (for example, a surface on which the first coil 100 is supported). In addition, another metal layer included in the first terminal 221 may be supported on the other side surface of the insulation layer 210 (for example, a surface on which the first coil 100 is not supported). In addition, the first terminal 221 supported on one side surface of the insulation layer 210 may be electrically connected with the first terminal 221 supported on the other side surface of the insulation layer 210. An electrical connection between the first terminals 221 may be established by a connection via including a conductive material and penetrating through the insulation layer 210.

The second terminal 222 may be provided as one or more metal layers connected with the second longitudinal end 115 of the coil 100. In other words, a portion of the second terminal 222 may be electrically, physically connected with the second longitudinal end 116 of the coil 100 disposed outside the loop 120 of the coil 100. When the second terminal 222 is a single metal layer, the second terminal may be disposed on one surface of the insulation layer 210. When the second terminal 222 includes a plurality of metal layers, one metal layer included in the second terminal 222 may be supported on one side surface of the insulation layer 210 (for example, a surface on which the first coil 100 is supported). In addition, another metal layer included in the second terminal 222 may be supported on the other side surface of the insulation layer 210 (for example, a surface on which the first coil 100 is not supported). In addition, the second terminal 222 supported on one side surface of the insulation layer 210 may be electrically connected with the second terminal 222 supported on the other side surface of the insulation layer 210. An electrical connection between the second terminals 222 may be established by a connection via including a conductive material and penetrating through the insulation layer 210.

The coil 100 may be electrically, physically connected with the flexible circuit board 200, and the connection between the coil 100 and the flexible circuit board 200 may be established by various methods. For example, the coil 100 and the conductive terminal 220 of the flexible circuit board 200 may be connected with each other by welding.

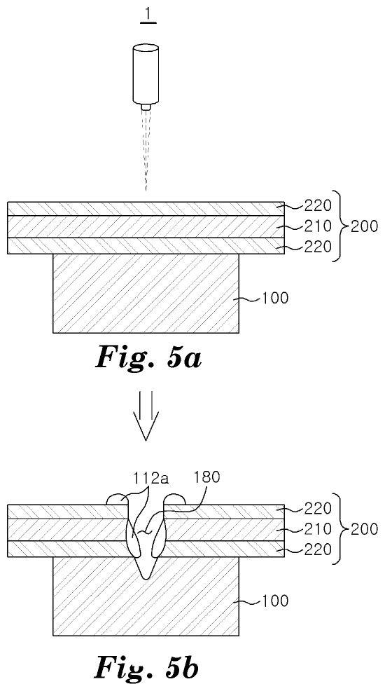

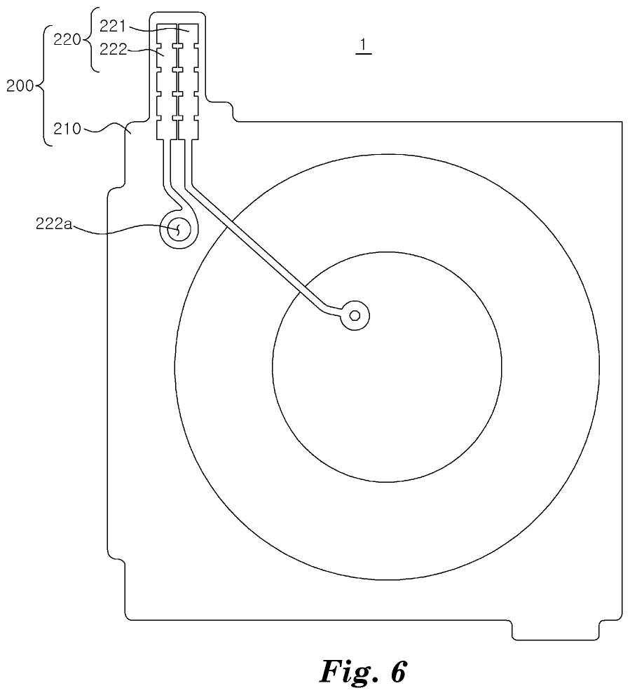

A process of terminating the coil 100 and the flexible circuit board 200 to each other through a laser beam will be described with reference to FIG. 5. First, when the coil 100 and the conductive terminal 220 are connected with each other by projecting a laser beam, the laser beam may be projected onto thinner one of the coil 100 and the flexible circuit board 200. When the flexible circuit board 200 has a thinner thickness, the laser beam may be projected onto the flexible circuit board 200.

When the laser beam is projected onto the flexible circuit board 200, the laser beam may be projected from one side of the insulation layer 210 where the coil 100 is not disposed. More specifically, the laser beam may be projected from one side of the both sides of the insulation layer 210 where the coil 100 is not disposed toward the conductive terminal 220 (see FIG. 5A). When the laser beam is projected onto the conductive terminal 220 as described above, a hole 180 penetrating through the conductive terminal 220 and the insulation layer 210 may be formed in the conductive terminal 220 and the insulation layer 210 by the laser beam projected onto the conductive terminal 220. In addition, after the hole 180 is formed, the laser beam may reach the coil 100 through the hole 180. As described above, the conductive terminal 220, the insulation layer 210, and the coil 100 may melt in sequence by the laser beam. In addition, as a portion of the conductive terminal 220, the insulation layer 210, and the coil 100 melts by the laser beam, the welding portion 112a may be formed. In this way, the coil 100 and the flexible circuit board 200 may be electrically connected with each other through the welding portion 112a (see FIG. 5B). For example, the laser projected onto the conductive terminal 220 may be a YAG laser. The wavelength of the YAG laser may be 1 um, and the frequency may be 300 THz.

The coil assembly 1 according to the first embodiment of the present disclosure as described above may require high power to melt the conductive terminal 220 without the insulation layer 210 by the laser, but the laser is repeatedly reflected within the insulation layer 210, so that there is an effect of melting the conductive terminal 220 with low power.

Although the welding portion is formed by the laser in the present embodiment, the technical concept of the present disclosure is not limited thereto. In another example, the welding portion may be formed by letting large current flow instantaneously (resistance welding or spot welding) or by using ultrasonic waves, and normal soldering may be used.

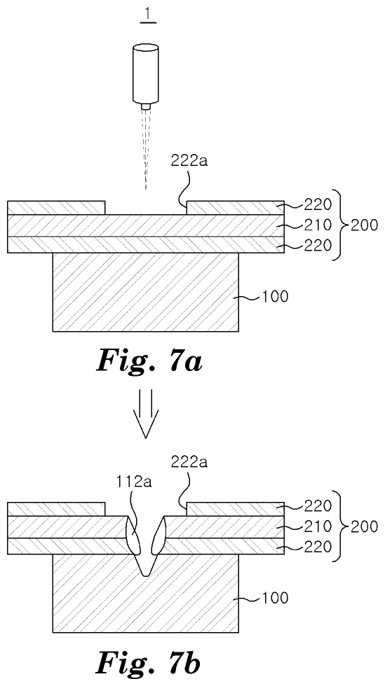

Hereinafter, a second embodiment of the present disclosure will be described with reference to FIGS. 6 and 7. In describing the second embodiment, the differences from the embodiment already described above are mainly described, and the same description and reference numerals are referred to the above.

Referring to FIGS. 6 and 7, an exposure portion 222a may already be formed on the conductive terminal 220 according to the second embodiment to expose the insulation layer 210 to the laser beam. In other words, the exposure portion 222a may be formed on one or more of the first terminal 221 and the second terminal 222 before the laser is projected. The exposure portion 222a may be a portion that is opened by removing a portion of the conductive terminal 220 out of the first terminal 221 and the second terminal 222, and may be formed through etching, etc. In addition, the exposure portion 222a may have a width wider than that of the welding portion 112a. Through the exposure portion 222a, the welding portion 112a and a portion of the insulation layer 210 adjacent to the welding portion 112a may be exposed to the outside. In addition, the exposure portion 222a may be formed on the first terminal 221 and the second terminal 222 supported on one side surface of the insulation layer 210 where the coil 100 is not disposed. As described above, the exposure portion 222a is formed on the conductive terminal 220 and the laser beam is directly projected onto the insulation layer 210 through the exposure portion 222a, so that a thickness of the welding portion 112a formed on the conductive terminal 220 can be reduced.

According to the second embodiment of the present disclosure described above, when the coil 100 and the flexible circuit board 200 are connected to each other through the laser, etc., the thickness of the flexible circuit board 200 can be prevented from becoming thicker due to by-products, or the flexible circuit board 200 can be prevented from being penetrated.

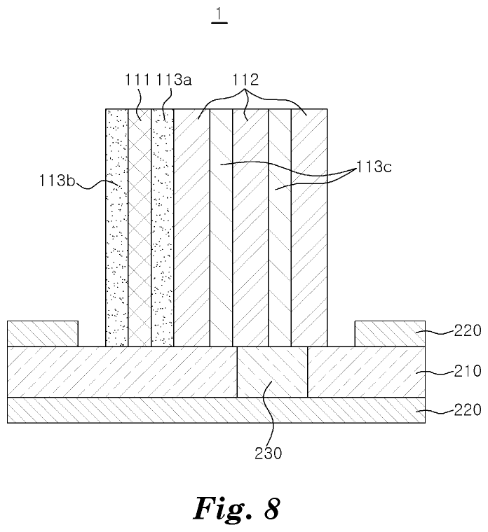

Hereinafter, a third embodiment of the present disclosure will be described with reference to FIG. 8. According to the third embodiment of the present disclosure, the flexible circuit board 200 may further include a conductive via 230. The conductive via 230 may electrically connected the metal layer 112 and the conductive terminal 220. In other words, the metal layer 112 and the conductive terminal 220 are connected to each other through the conductive via 230, such that current flows between the metal layer 112 and the conductive terminal 220. For example, the conductive via 230 may be supported on the insulation layer 210 by soldering. The conductive via 230 may be filled with a conductive material. In addition, the insulation layer 210 may have a penetrating hole formed therein to allow the conductive via 230 to be inserted thereinto.

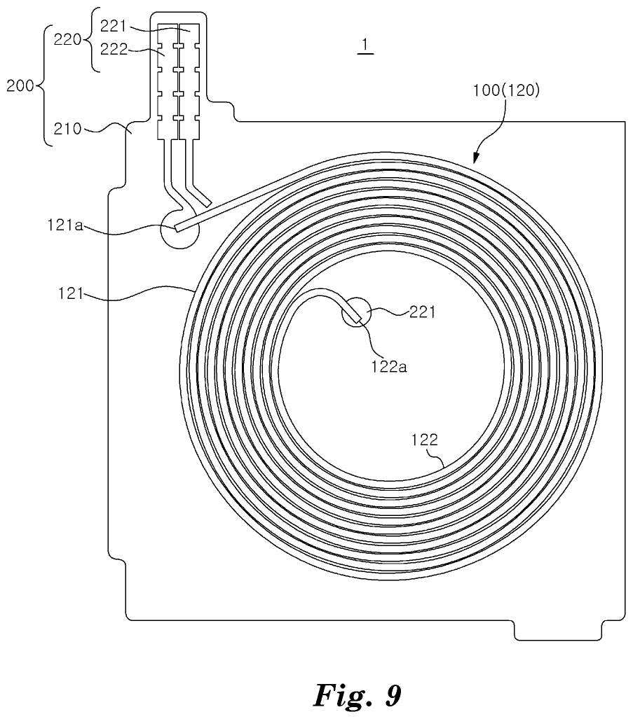

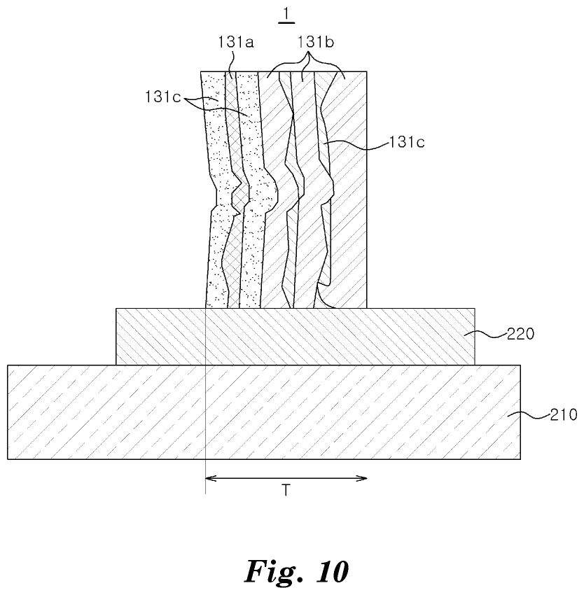

Hereinafter, a fourth embodiment of the present disclosure will be described with reference to FIGS. 9 and 10. According to the fourth embodiment of the present disclosure, the coil may include a wire 130. The wire 130 may be wound to form a plurality of loops 120 which are substantially concentric. In addition, the wire 130 may include a stacking layer 131.

A plurality of stacking layers 131 may be provided. The plurality of stacking layers may have substantially coextensive length and width (W), respectively, between a first end 121a and a second end 122a of the wire 130. In other words, the plurality of stacking layers may have substantially the same widths, and may substantially form one end. The stacking layer 131 may include a magnetic layer 131a, a metal layer 131b, and an adhesive layer 131c. A plurality of metal layers 131b and A plurality of adhesive layers 131c may be alternately arranged. In addition, the plurality of metal layers 131b may be electrically, physically connected with one another, and may be electrically, physically connected to the conductive terminal 220 of the flexible circuit board 200. The plurality of magnetic layers 131a, the plurality of metal layers 131b, and the plurality of adhesive layers 131c may have uneven surfaces. Regarding other descriptions of the magnetic layer 131a, the metal layer 131b, and the adhesive layer 131c of the fourth embodiment, references are made to the descriptions of the magnetic layer 111, the metal layer 112, and the adhesive layer 113 of the first embodiment.

In addition, the plurality of loops 120 of the wire 130 may include an outermost loop 121 including the first end 121a of the wire 130, and an innermost loop 122 including the second end 122a of the wire 130.

The outermost loop 121 is a loop 120 that is disposed on the outermost edge of the plurality of loops 120 of the coil 120 and is exposed to the outside, and may include the first end 121a which is an end of one side of the wire 130.

The innermost loop 122 is a loop 120 that is disposed on the innermost side of the plurality of loops 120 of the coil 100 and is exposed to the outside, and may include the second end 122a which is an end of the other side of the wire 130.

As shown in FIG. 10, at the first end 121a and the second end 122a of the wire 130, respectively, the wire 130 may be seated on the conductive terminal 220 to have the thickness direction of the wire 130 substantially perpendicular to the conductive terminal.

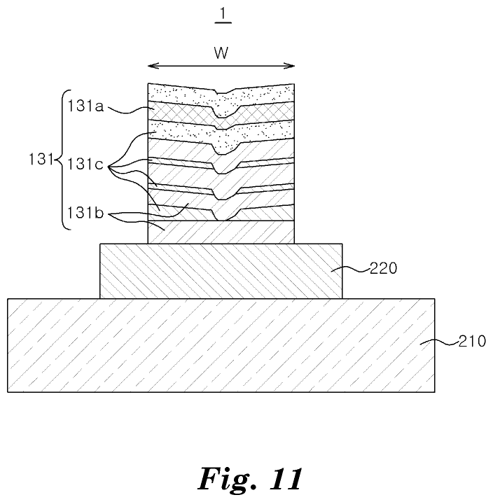

Hereinafter, a fifth embodiment of the present disclosure will be described with reference to FIG. 11. According to the fifth embodiment of the present disclosure, at the first end 121a and the second end 122a of the wire 130, respectively, the wire 130 may be seated on the conductive terminal 220 to have the thickness direction (for example, the horizontal direction of FIG. 10, the vertical direction of FIG. 11) of the wire 130 substantially horizontal to the conductive terminal. The thickness direction of the wire 130 may be a direction in which the magnetic layer 131a, the metal layer 131b, and the adhesive layer 131c of the wire 130 are stacked.

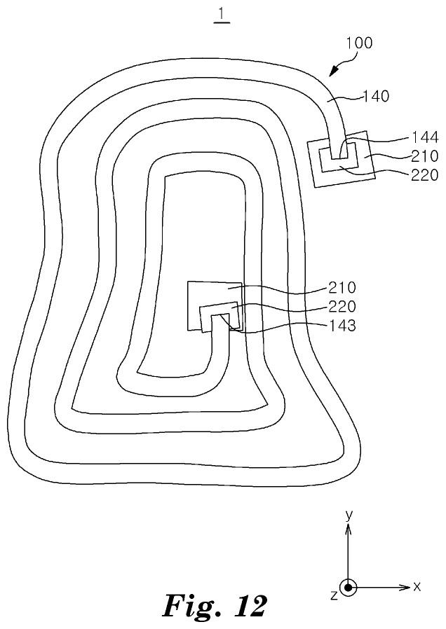

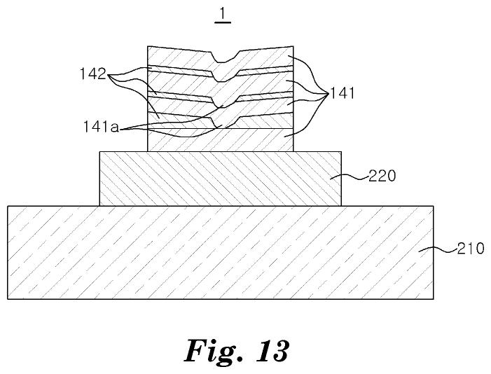

Hereinafter, a sixth embodiment of the present disclosure will be described with reference to FIGS. 12 and 13. According to the sixth embodiment of the present disclosure, the coil may include a plurality of coil turns 140. Referring to FIG. 12, the coil turns 140 may be wound to form the plurality of loops 120, and may be wound in a form other than the form of the concentric loop 120. In other words, the coil turns 140 may be wound in a curved form other than a circular form. In addition, the coil turns 140 may include a plurality of metal layers 141 and a plurality of adhesive layers 142 which are alternated. The plurality of metal layers 141 and the plurality of adhesive layers 142 may be stacked along a surface direction of the coil 100, and may have uneven surfaces. In addition, the respective coil turns 140 may be substantially extended between a first longitudinal end 143 and a second longitudinal end 144 of the coil 100 which are disposed opposite to each other.

At one or more of the first longitudinal end 143 and the second longitudinal end 144 of the coil 100, the metal layers 141 of the plurality of metal layers 141 and the plurality of adhesive layers 142 alternating one another may be electrically connected to the conductive terminal 220 of the flexible circuit board 200.

Referring to FIG. 13, the plurality of metal layers 141 may be electrically connected with one another. One or more of the plurality of metal layers 141 may have a connection portion 141a for connecting some of the plurality of metal layers 141. As described above, in each pair of adjacent metal layers of the plurality of metal layers 141, main surfaces of the metal layer 141 facing another metal layer 141 may be connected with each other through the connection portion 141a.

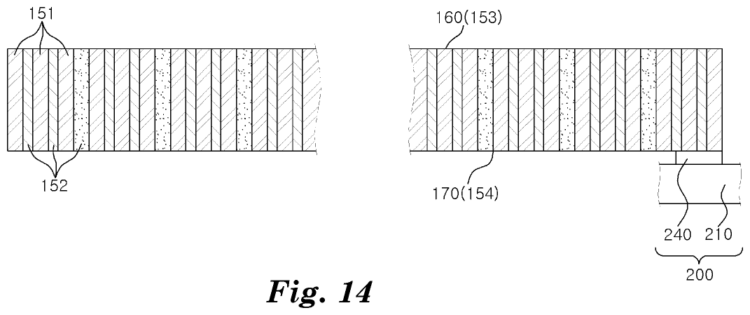

Hereinafter, a seventh embodiment of the present disclosure will be described with reference to FIGS. 14 to 16. According to the seventh embodiment of the present disclosure, the coil 100 may have a substantially flat surface. The coil 100 may include a multilayer film 150, a first main surface 160, and a second main surface 170.

The coil 100 may include a first longitudinal end 157 and a second longitudinal end 158 which are provided opposite to each other, and the multilayer film 150 may be extended between the first longitudinal end 157 and the second longitudinal end 158 of the coil 100. The multilayer film 150 may be wound to form a plurality of loops 120 of the coil 100 which are substantially concentric. In addition, the multilayer film 150 may include a metal layer 151, an adhesive layer 152, a first end surface 153, a second end surface 154, a first side surface 155, and a second side surface 156.

A plurality of metal layers 151 and a plurality of adhesive layers 152 may be provided, and the plurality of metal layers 151 and the plurality of adhesive layers 152 may be arranged alternately. The metal layer 151 may be electrically connected to a conductive layer 240 and may be disposed on the conductive layer 240 in such a manner that one of the first end surface 153 and the second end surface 154 faces the conductive layer 240, which will be described below, and the first side surface 155 and the second side surface 156 are substantially perpendicular to the conductive layer 240.

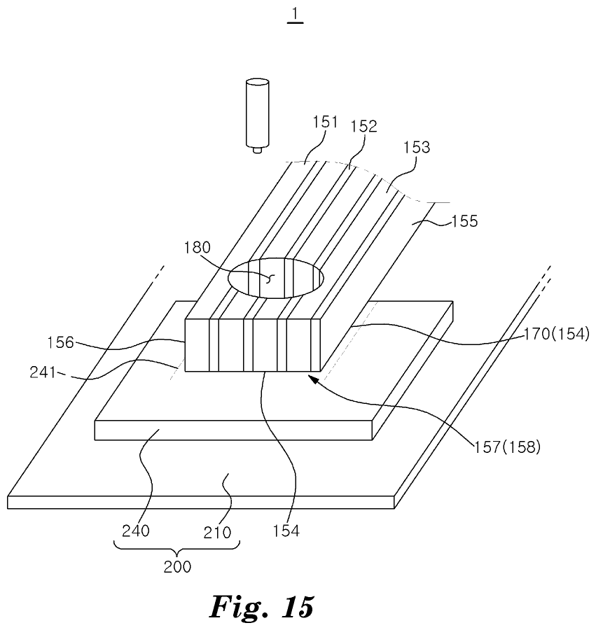

The adhesive layer 152 may bond adjacent loops 120 to each other. In addition, one side surface (for example, a lower surface of FIG. 15) of each adhesive layer 152 may face the conductive layer 240 within a first region 241, and may be disposed on the periphery of the conductive layer 240 within the first region 241. The one side surface of the adhesive layer 152 may be a portion of the second end surface 154.

The first end surface 153 may be disposed on the first main surface 160, and may be disposed opposite to the second end surface 154 and may be a substantially flat surface. The first end surface 153 may be one side surface (for example, an upper surface of FIG. 15) of the multilayer film 150, and may be a surface spaced apart from the conductive layer 240.

The second end surface 154 may be disposed on the second main surface 170, and may be disposed opposite to the first end surface 153 and may be a substantially flat surface. The second end surface 154 may be the other side surface (for example, a lower surface of FIG. 15) of the multilayer film 150. In addition, the second end surface 154 may be formed in parallel with the first end surface 153. A portion of the second end surface 154 may be electrically connected with the conductive layer 240 in contact therewith.

The first side surface 155 and the second side surface 156 may be connected to the first end surface 153 and the second end surface 154, respectively. In addition, the first side surface 155 and the second side surface 156 may be oriented substantially along the thickness direction of the coil 100. The first side surface 155 and the second side surface 156 may be disposed opposite to each other, and may be formed in parallel with each other. For example, the first side surface 155 and the second side surface 156 may be substantially flat surfaces. In addition, the first side surface 155 and the second side surface 156 may be extended to be perpendicular to the first end surface 153 and the second end surface 154, respectively.

The first main surface 160 and the second main surface 170 may be disposed opposite to each other, and may be substantially flat surfaces. The first main surface 160 may be one side surface (for example, an upper surface of FIG. 14) of the wound coil 100, and the second main surface 170 may be the other side surface (for example, a lower surface of FIG. 14) of the wound coil 100. In addition, a distance between the first main surface 160 and the second main surface 170 which are disposed opposite to each other and are flat surfaces may be 50 um-1 mm inclusive. The insulation layer 210, which will be described below, may be disposed on a portion of the first main surface 160, and the insulation layer 210 may also be disposed on a portion of the second main surface 170.

The conductive layer 240 described hereinbelow may be understood as the conductive terminal 220 of FIG. 7. In other words, a first conductive layer 240 and a second conductive layer 240 may be understood as the conductive terminals 220 disposed on both sides of the insulation layer 210 of FIG. 7. The exposure portion 222a as shown in FIG. 7 may be provided in the conductive layer 240, and the welding portion 112a may be provided in one or more of the insulation layer 210 and the conductive layer 240.

The flexible circuit board 200 may include the insulation layer 210 and the conductive layer 240. In addition, the conductive layer 240 may include a material through which current flows, and may be disposed on the insulation layer 210. The conductive layer 240 may include the first conductive layer 240 and the second conductive layer 240 disposed opposite to the first conductive layer 240. The insulation layer 210 may be disposed between the first conductive layer 240 and the second conductive layer 240. The exposure portion 222a having a larger size than the welding portion 112a may be formed in the second conductive layer 240. In addition, the conductive layer 240 may include the first region 241 where the coil 100 is seated on the conductive layer 240. The first region 241 may be a concept including a space where the coil 100 is disposed on the conductive layer 240.

The coil assembly 1 according to the seventh embodiment may further include the welding portion 112a. The welding portion 112a may be provided in one or more of the insulation layer 210 and the conductive layer 240 to electrically connect the insulation layer 210 and the conductive layer 240 to each other. In addition, the welding portion 112a may be positioned to correspond to the exposure portion 222a.

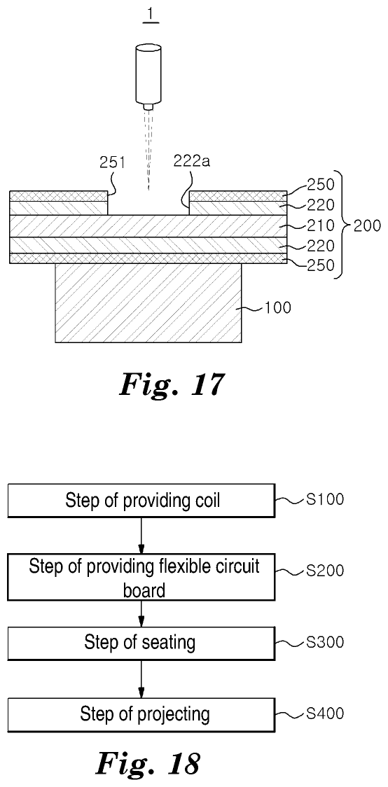

Hereinafter, an eighth embodiment of the present disclosure will be described with reference to FIG. 17. According to the eighth embodiment of the present disclosure, the flexible circuit board 200 may further include an absorption layer 250 to absorb energy received from the laser beam, and to transmit the energy to the conductive terminal 220 in order to increase an absorption ratio of the laser beam. The absorption layer 250 may be bonded to one surface of the conductive terminal 220, and the conductive terminal 220 may be disposed between the absorption layer 250 and the insulation layer 210. In addition, the absorption layer 250 may include a metallic material capable of absorbing energy of a laser beam with high efficiency. For example, the absorption layer may include gold (Ag), silver (Au), tin, etc.

Accordingly, when the flexible circuit board 200 further includes the absorption layer 250, the conductive terminal of the flexible circuit board 200 may melt even by a laser of low power, and may be bonded to the coil 100. An opening 251 may be formed in at least a portion of the absorption layer 250. The opening 251 may be formed to correspond to a shape of the exposure portion 222a of the conductive terminal 220, and may be formed on a position corresponding to the exposure portion 222a. As described above, the opening 251 may be formed on the position corresponding to the exposure portion 222a, such that the laser is projected onto the insulation layer 210 through the opening 251 and the exposure portion 222a.

Hereinafter, a method (S10) of terminating a coil to a conductive layer according to an embodiment of the present disclosure will be described with reference to FIG. 18.

The method (S10) of terminating the coil to the conductive layer may include a step of providing a coil (S100), a step of providing a flexible circuit board (S200), a step of seating (S300), and a step of projecting (S400).

At the step of providing the coil (S100), the coil 100 which includes the multilayer film 150 and has a substantially flat surface may be provided. The multilayer film 150 provided in the coil 100 may be extended between the first longitudinal end 157 and the second longitudinal end 158 of the coil 100 which are disposed opposite to each other. In addition, the multilayer film 150 may be wound to form the plurality of loops 120 of the coil 100 which are substantially concentric, and may include the plurality of metal layers 151 and the plurality of adhesive layers 152 which are alternated. The plurality of loops 120 may be continuous and may have a spiral shape.

At the step of providing the flexible circuit board (S200), the flexible circuit board 200 including the insulation layer 210 and the conductive layer 240 may be provided (the step of providing the flexible circuit board (S200)). The conductive layer 240 provided at the step of providing the flexible circuit board (S200) may be disposed on the insulation layer 210.

At the step of seating (S300), the first longitudinal end 157 of the coil 100 may be seated on the upper side of the first region 241 of the conductive layer 240 and on the periphery of the first region 241, such that side surfaces of the respective adhesive layers 152 face the conductive layer 240 within the first region 241, and are disposed on the periphery of the conductive layer 240 within the first region 241.

At the step of projecting (S400), a laser beam may be projected toward the conductive layer 240 to laser weld at least some of the plurality of metal layers 151 to the conductive layer 240. As described above, at the step of projecting (S400), the laser beam may be projected toward the conductive layer 240, such that at least some of the plurality of metal layers 151 are bonded to the conductive layer 240. When at least some of the plurality of metal layers 151 are bonded to the conductive layer 240 as described above, the coil 100 may be electrically terminated to the conductive layer 240.

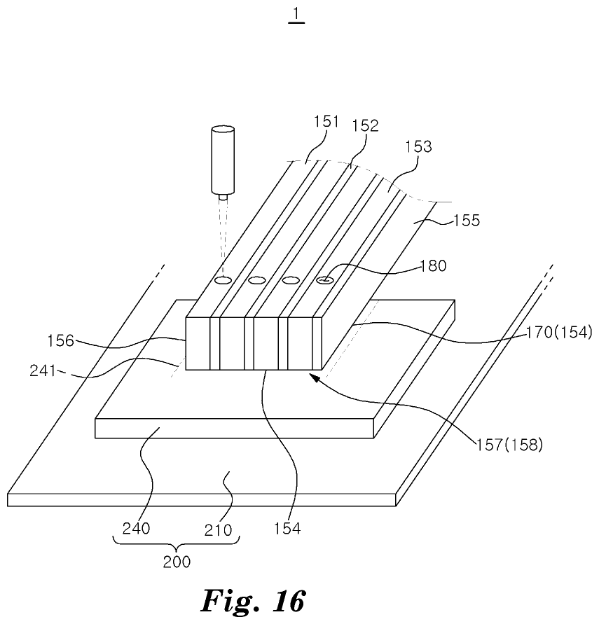

At the step of projection (S400), as shown in FIG. 15, the laser may be projected onto a partial region of the multilayer film 150, such that the multilayer film 150 and the conductive layer 240 are connected with each other, and also, as shown in FIG. 16, the laser may be projected onto the plurality of metal layers 151, such that the plurality of metal layers 141 and the conductive layer 240 are connected to each other. In other words, at the step of projecting (S400), the laser beam may be projected onto the plurality of metal layers 151, such that the plurality of metal layers 151 and the conductive layer 240 are bonded to each other.

In addition, at the step of projecting (S400), the laser beam and the first longitudinal end 157 of the coil 100 may be on the same plane of the conductive layer 240. In this case, at the step of projecting (S400), when the laser beam is projected toward the first longitudinal end 157 of the coil 100 within the first region 241, the hole 180 may be formed in the coil 100 by the laser beam projected onto the coil 100. In addition, after the hole 180 is formed, the laser beam may reach the conductive layer 240 through the hole 180. Accordingly, the laser beam may be projected onto the first longitudinal end 157, the conductive layer 240 in sequence, such that the conductive layer 240 and the first longitudinal end 157 are bonded to each other.

On the other hand, at the step of projecting (S400), the laser beam and the first longitudinal end 157 of the coil 100 may be on the opposite surfaces of the conductive layer 240. In other words, the laser beam may be on one side surface of the conductive layer 240, and the first longitudinal end 157 of the coil 100 may be on the other side surface of the conductive layer 240. In this case, at the step of projecting (S400), when the laser beam is projected toward the conductive layer 240 within the first region 241, the hole 180 may be formed on the conductive layer 240 by the laser beam projected onto the conductive layer 240. In addition, after the hole 180 is formed, the laser beam may reach the coil 100 through the hole 180. Accordingly, the laser beam may be projected onto the insulation layer 210, the conductive layer 240, and a portion of the first longitudinal end 157 in sequence, such that the conductive layer 240 and the first longitudinal end 157 are bonded to each other. In addition, at the step of projecting (S400), the laser beam may be projected onto the insulation layer 210 through the exposure portion 222a. In other words, the laser beam may not be projected onto the second conductive layer 140 and may be directly projected onto the insulation layer 210 through the exposure portion 222a, such that the insulation layer 210 melts and a portion of the first conductive layer 140 and a portion of the first longitudinal end 157 are bonded to each other by the laser beam.

The following is a list of embodiments of present disclosure.

Item 1 relates to a coil assembly including a coil including a multilayer film which is extended between a first longitudinal end and a second longitudinal end of the multilayer film, which are opposite to each other, and which is wound to form a plurality of loops which are substantially concentric, wherein the multilayer film includes: cut edges which are extended between the first longitudinal end and the second longitudinal end, and are opposite to each other and are substantially parallel to each other; a metal layer; and a magnetic layer disposed on the metal layer, wherein, at one or more of the first longitudinal end and the second longitudinal end of the multilayer film, the multilayer film is electrically connected to a conductive terminal.

Item 2 relates to the coil assembly, wherein the metal layer is physically connected to the conductive terminal.

Item 3 relates to the coil assembly, wherein the metal layer is physically, electrically connected to the conductive terminal through a welding portion provided in one or more of the metal layer and the conductive terminal.

Item 4 relates to the coil assembly, wherein the metal layer is electrically connected to the conductive terminal through a conductive via.

Item 5 relates to the coil assembly, wherein the conductive via is substantially filled with a conductive material.

Item 6 relates to the coil assembly, wherein the multilayer film further includes an adhesive layer, and wherein adjacent loops of the plurality of loops which are substantially concentric are coupled to each other by the adhesive layer.

Item 7 relates to the coil assembly, wherein the metal layer is electrically connected to the conductive terminal of a flexible circuit board.

Item 8 relates to the coil assembly, wherein the metal layer is electrically connected to the conductive terminal disposed on an insulation layer of the flexible circuit board.

Item 9 relates to the coil assembly, wherein the multilayer film further includes a first adhesive layer disposed between the magnetic layer and the metal layer, and the magnetic layer is disposed on the first adhesive layer.

Item 10 relates to the coil assembly, wherein the multilayer film further includes a second adhesive layer, and wherein the magnetic layer is disposed between the first adhesive layer and the second adhesive layer.

Item 11 relates to a coil assembly including a coil including a continuous wire which is wound to form a plurality of loops, the plurality of loops including an outermost loop including a first end of the wire, and an innermost loop including a second end opposite to the first end of the wire, the plurality of loops being substantially concentric, wherein the wire includes a plurality of stacking layers which have substantially coextensive length and width between the first end and the second end of the wire, respectively, wherein the plurality of stacking layers include a magnetic layer and a plurality of metal layers and a plurality of adhesive layers which are alternated, wherein, at the first end and the second end of the wire, respectively, the plurality of metal layers are electrically, physically connected with one another, and are electrically, physically connected to a conductive terminal of a flexible circuit board.

Item 12 relates to the coil assembly, wherein, at the first end and the second end of the wire, respectively, the wire is seated on the conductive terminal to have a thickness direction of the wire substantially perpendicular to the conductive terminal.

Item 13 relates to the coil assembly, wherein, at the first end and the second end of the wire, respectively, the wire is seated on the conductive terminal to have a thickness direction of the wire substantially horizontal to the conductive terminal.

Item 14 relates to a coil assembly including a coil including a plurality of coil turns, wherein each of the coil turns includes a plurality of metal layers and a plurality of adhesive layers which are stacked along a surface direction of the coil and are alternated, the coil turns being substantially extended between a first longitudinal end and a second longitudinal end of the coil which are opposite to each other, wherein, at one or more of the first longitudinal end and the second longitudinal end of the coil, the metal layers of the plurality of metal layers and the plurality of adhesive layers which are alternated are electrically connected to a conductive terminal of a flexible circuit board.

Item 15 relates to the coil assembly, wherein the plurality of metal layers are electrically connected with one another.

Item 16 relates to the coil assembly, wherein one or more of the plurality of metal layers have a connection portion, and wherein, in each pair of adjacent metal layers of the plurality of metal layers, main surfaces of the metal layer facing another metal layer are connected with each other through the connection portion.

Item 17 relates to a coil assembly including: a flexible circuit board including a conductive layer disposed on an insulation layer; and a coil including first and second main surfaces which are opposite to each other and are substantially flat surfaces, and a multilayer film which is extended between a first longitudinal end and a second longitudinal end of the coil opposite to each other, and is wound to form a plurality of loops of the coil which are substantially concentric, the coil having a substantially flat surface, wherein the multilayer film further includes: a plurality of metal layers and a plurality of adhesive layers which are alternated; first and second end surfaces which are disposed on the first main surface and the second main surface of the coil, respectively, and are opposite to each other and are substantially flat surfaces, and are parallel to each other; and first and second side surfaces which are connected to the first and second end surfaces and are substantially oriented along a thickness direction of the coil, and are opposite to each other, are substantially flat surfaces, and parallel to each other, wherein, at one or more of the first longitudinal end and the second longitudinal end of the coil, the metal layer of the multilayer film is electrically connected to the conductive layer and is disposed on the conductive layer in such a manner that one of the first and second end surfaces of the multilayer film faces the conductive layer, and the first and second side surfaces of the multilayer film are substantially perpendicular to the conductive layer.

Item 18 relates to the coil assembly, wherein adjacent loops of the loops are coupled to each other by the adhesive layer.

Item 19 relates to the coil assembly, wherein a distance between the first and second main surfaces which are opposite to each other and are flat surfaces is 50 um-1 mm inclusive.

Item 20 relates to the coil assembly, wherein a portion of one of the first and second main surfaces is disposed on the insulation layer.

Item 21 relates to the coil assembly, wherein the conductive layer is electrically connected to the insulation layer through a welding portion provided in one or more of the insulation layer and the conductive layer.

Item 22 relates to the coil assembly, wherein the conductive layer includes a first conductive layer and a second conductive layer having an exposure portion having a larger size than the welding portion, and wherein the insulation layer is disposed between the first conductive layer and the second conductive layer.

Item 23 relates to the coil assembly, wherein the exposure portion is positioned to correspond to the welding portion.

Item 24 relates to the coil assembly further including an absorption layer configured to absorb energy and transmit the energy to the conductive terminal, wherein the conductive terminal is disposed between the absorption layer and an insulation layer.

Item 25 relates to the coil assembly, wherein an exposure portion is formed in the conductive terminal, and wherein an opening is formed in the absorption layer to correspond to the exposure portion.

Item 26 relates to the coil assembly, wherein the absorption layer includes one or more of gold (Au), silver (Au), and tin (Sg).

Item 27 relates to a method of terminating a coil to a conductive layer, the method including the steps of: providing a coil, the coil including a multilayer film which is extended between a first longitudinal end and a second longitudinal end of the coil opposite to each other, and is wound to form a plurality of loops of the coil which are substantially concentric, the multilayer film including a plurality of metal layers and a plurality of adhesive layers which are alternated, the coil having a substantially flat surface; providing a flexible circuit board, the flexible circuit board including a conductive layer disposed on an insulation layer; seating the first longitudinal end of the coil on an upper side of a first region of the conductive layer and on the periphery of the first region, such that one side surface of each of the adhesive layers face the conductive layer within the first region and is disposed on the periphery of the conductive layer within the first region; and projecting a laser beam toward the first region to laser weld at least some of the plurality of metal layers to the conductive layer.

Item 28 relates to the method of terminating the coil to the conductive layer, wherein the laser beam and the first longitudinal end of the coil are on the same surface of the conductive layer.

Item 29 relates to the method of terminating the coil to the conductive layer, wherein the laser beam and the first longitudinal end of the coil are on opposite surfaces of the conductive layer.

Item 30 relates to the method of terminating the coil to the conductive layer, wherein the conductive layer includes a first conductive layer and a second conductive layer having an exposure portion formed therein, and wherein the laser beam is projected onto the insulation layer through the exposure portion.

Item 31 relates to the method of terminating the coil to the conductive layer, wherein, after a hole is formed in the coil by the laser beam projected onto the coil, the laser beam reaches the conductive layer through the hole.

Item 32 relates to the method of terminating the coil to the conductive layer, wherein, after a hole is formed in the conductive layer by the laser beam projected onto the conductive layer, the laser beam reaches the coil through the hole.

Although embodiments of the present disclosure have been described by referring to specific embodiments, these are merely certain examples, and the present disclosure is not limited thereto, and should be interpreted as having the broadest scope according to the basic idea disclosed herein. Those skilled in the art will be able to combine and/or substitute the disclosed embodiments to effect a pattern of a shape that has not been stated herein, but this also does not depart from the scope of the present disclosure. Further, it will be apparent to those skilled in the art that various changes and modifications may be readily made without departing from the idea and scope of the invention as defined by the appended claims.

### DESCRIPTION OF REFERENCE NUMERALS

| | |
|---|---|
| 1: coil assembly | 100: coil |
| 110, 150: multilayer film | 111, 131a: magnetic layer |
| 112, 131b, 141, 151: | 112a: welding portion |
| metal layer | |
| 113, 131c, 142, 152: | 113a: first adhesive layer |
| adhesive layer | |
| 113b: second adhesive | 113c: third adhesive layer |
| layer | |
| 114: cut edge | 141a: connection portion |
| 115, 143, 157 first | |
| longitudinal end | |
| 116, 144, 158: second | 120: loop |
| longitudinal end | |
| 121: outermost loop | 121a: first end |
| 122: innermost loop | 122a: second end |
| 130: wire | 131: stacking layer |
| 140: coil turn | 153: first end surface |
| 154: second end surface | 155: first side surface |
| 156: second side layer | 160: first main surface |
| 170: second main surface | 200: flexible circuit board |
| 210: insulation layer | 220: conductive terminal |
| 221: first terminal | 222: second terminal |
| 222a: exposure portion | 230: conductive via |
| 240: conductive layer | 241: first region |
| 250: absorption layer | 251: opening |

1. A coil assembly comprising a coil comprising a multilayer film which is extended between a first longitudinal end and a second longitudinal end of the multilayer film, which are opposite to each other, and which is wound to form a plurality of loops which are substantially concentric,
wherein the multilayer film comprises: cut edges which are extended between the first longitudinal end and the second longitudinal end, and are opposite to each other and are substantially parallel to each other;
a metal layer; and a magnetic layer disposed on the metal layer,
wherein, at one or more of the first longitudinal end and the second longitudinal end of the multilayer film, the metal layer is electrically connected to a conductive terminal.

2. The coil assembly of claim 1,
wherein the metal layer is physically connected to the conductive terminal.

3. The coil assembly of claim 2,
wherein the metal layer is physically, electrically connected to the conductive terminal through a welding portion provided in one or more of the metal layer and the conductive terminal.

4. The coil assembly of claim 1,
wherein the metal layer is electrically connected to the conductive terminal through a conductive via.

5. The coil assembly of claim 4,
wherein the conductive via is substantially filled with a conductive material.

6. The coil assembly of claim 1,
wherein the multilayer film further comprises an adhesive layer, and
wherein adjacent loops of the plurality of loops which are substantially concentric are coupled to each other by the adhesive layer.

7. The coil assembly of claim 1,
wherein the metal layer is electrically connected to the conductive terminal of a flexible circuit board.

8. The coil assembly of claim 7,
wherein the metal layer is electrically connected to the conductive terminal disposed on an insulation layer of the flexible circuit board.

9. The coil assembly of claim 1,
wherein the multilayer film further comprises a first adhesive layer disposed between the magnetic layer and the metal layer, and the magnetic layer is disposed on the first adhesive layer.

10. The coil assembly of claim 9,
wherein the multilayer film further comprises a second adhesive layer, and
wherein the magnetic layer is disposed between the first adhesive layer and the second adhesive layer.

11. A coil assembly comprising a coil comprising a continuous wire which is wound to form a plurality of loops, the plurality of loops comprising an outermost loop comprising a first end of the wire, and an innermost loop comprising a second end opposite to the first end of the wire, the plurality of loops being substantially concentric,
wherein the wire comprises a plurality of stacking layers which have substantially coextensive length and width between the first end and the second end of the wire, respectively,
wherein the plurality of stacking layers comprise a magnetic layer and a plurality of metal layers and a plurality of adhesive layers which are alternated,
wherein, at the first end and the second end of the wire, respectively, the plurality of metal layers are electrically, physically connected with one another, and are electrically, physically connected to a conductive terminal of a flexible circuit board.

12. The coil assembly of claim 11,
wherein, at the first end and the second end of the wire, respectively, the wire is seated on the conductive terminal to have a thickness direction of the wire substantially perpendicular to the conductive terminal.

13. The coil assembly of claim 11,
wherein, at the first end and the second end of the wire, respectively, the wire is seated on the conductive terminal to have a thickness direction of the wire substantially horizontal to the conductive terminal.

14. A coil assembly comprising a coil comprising a plurality of coil turns,
wherein each of the coil turns comprises a plurality of metal layers and a plurality of adhesive layers which are stacked along a surface direction of the coil and are alternated, the coil turns being substantially extended between a first longitudinal end and a second longitudinal end of the coil which are opposite to each other,
wherein, at one or more of the first longitudinal end and the second longitudinal end of the coil, the metal layers of the plurality of metal layers and the plurality of adhesive layers which are alternated are electrically connected to a conductive terminal of a flexible circuit board.

15. The coil assembly of claim 14,
wherein the plurality of metal layers are further electrically connected with one another.

16. The coil assembly of claim 14,
wherein one or more of the plurality of metal layers have a connection portion, and
wherein, in each pair of adjacent metal layers of the plurality of metal layers, main surfaces of the metal layer facing another metal layer are connected with each other through the connection portion.

17-32. (canceled)
